(19) United States
(12) Patent Application Publication
(10) Pub. No.: US 2018/0338093 A1
(43) Pub. Date: Nov. 22, 2018

(54) EYE-TRACKING-BASED IMAGE TRANSMISSION METHOD, DEVICE AND SYSTEM

(71) Applicant: CAFE24 CORP., Seoul (KR)

(72) Inventor: Jae Suk LEE, Seoul (KR)

(73) Assignee: CAFE24 CORP., Seoul (KR)

(21) Appl. No.: 15/552,495

(22) PCT Filed: Apr. 22, 2016
(86) PCT No.: PCT/KR2016/004212

§ 371 Date: Aug. 22, 2017

(30) Foreign Application Priority Data
Dec. 4, 2015 (KR) 10-2015-0172168
Jan. 14, 2016 (KR) 10-2016-0004485

(51) Int. Cl. H04N 5/262; G06F 3/01; H04N 5/44

(52) U.S. Cl. CPC H04N 5/2624; H04N 5/247; H04N 5/4403; G06F 3/013

(57) ABSTRACT

Disclosed are an eye-tracking-based image transmission method, device and system. The eye-tracking-based image transmission method enables: receiving multiple images acquired from multiple cameras; generating a synthesized image on the basis of the multiple images; displaying the synthesized image on a screen; detecting the gaze of a user in real-time; selecting, from the synthesized image, the image corresponding to an area at which the user is gazing; and transmitting the selected image. Thus, an image that dynamically changes according to the gaze of a user may be provided via broadcasting.

### TECHNICAL FIELD

The present invention relates to an image transmission method, device and system based on eye tracking and, more particularly, to an image transmission method, device and system based on eye tracking, wherein a composite image of a wide area is generated based on a plurality of images and a transmission area is selected in response to a movement of a user's eyes and transmitted.

### BACKGROUND ART

Recently, with the development of the live streaming technology, the user base of personal broadcasting based on the Internet is increasing rapidly. Moreover, as Internet personal broadcasting recently provides various and professional content, it has advanced to one format of a public airwaves entertainment program.

Personal broadcasting managed by a person may be compared with public airwaves broadcasting in many ways. One of the many ways is the number of cameras managed. That is, in this case, the number of cameras managed means how many cameras are managed in order to photograph a broadcasting program.

In general, in personal broadcasting by one person, one person who takes the lead of broadcasting performs broadcasting, and only one camera or a small number of cameras chiefly fixed to a monitor have to be used because a separate cameraman is not present. Accordingly, since an area photographed by a web camera is also fixed, it is a fact that there is a limit to the dynamic transfer of a scene or situation that wants to be shown by a user.

### DISCLOSURE

### Technical Problem

The present invention is for solving such a problem, and an object of the present invention is to provide an image transmission method, device and system based on eye tracking, which are capable of generating a composite image of a wide area based on a plurality of images, selecting a transmission area in response to a movement of a user's eyes, and sending the selected transmission area.

### Technical Solution

In order to accomplish the object, in an aspect, the present invention provides an image transmission method based on eye tracking. The image transmission method based on eye tracking is an image transmission method performed by an image transmission device, and includes the steps of receiving a plurality of images obtained by a plurality of cameras; generating a composite image based on the plurality of images; displaying the composite image on a screen; detecting a user's eyes in real time; selecting an image belonging to the composite image and corresponding to an area watched by the user; and sending the selected image.

The step of generating the composite image may includes the step of generating a single image including the plurality of images in addition to the plurality of images obtained by the plurality of cameras.

The step of selecting the image may includes the steps of dividing the composite image into a plurality of areas; determining that the detected eyes looks at which area of the plurality of areas; and selecting an image corresponding to the area watched by the user based on the determining step. The plurality of areas may correspond to the plurality of images obtained by the plurality of cameras.

The step of selecting the image may includes the step of selecting an image corresponding to a previously determined area if it is detected that the user looks at an area other than the screen.

The selected image may have the same size and resolution as an image obtained by a single camera. The plurality of cameras may include a main camera and at least one sub-camera.

Meanwhile, in order to accomplish the object of the present invention, in another aspect, the present invention provides an image transmission device based on eye tracking. The image transmission device based on eye tracking may include an image reception unit receiving a plurality of images obtained by a plurality of cameras; a composite image generation unit generating a composite image based on the plurality of images; a display unit displaying the composite image on a screen; an eye tracking unit detecting a user's eyes in real time; an image selection unit selecting an image belonging to the composite image and corresponding to an area watched by the user; and an image transmission unit sending the selected image.

The composite image generation unit may generate a single image including the plurality of images in addition to the plurality of images obtained by the plurality of cameras.

The image selection unit may divide the composite image into a plurality of areas, may determine that the detected eyes looks at which area of the plurality of areas, and may select an image corresponding to the area watched by the user based on the determination.

The plurality of areas may correspond to the plurality of images obtained by the plurality of cameras. The image selection unit may select an image corresponding to a previously determined area if it is detected that the user looks at an area other than the screen.

The selected image may have the same size and resolution as an image obtained by a single camera. The plurality of cameras may include a main camera and at least one sub-camera.

Meanwhile, in order to accomplish the object of the present invention, in yet another aspect, the present invention provides an image transmission system based on eye tracking. The image transmission system based on eye tracking may include a plurality of cameras; and an image transmission device receiving a plurality of images obtained by a plurality of cameras, generating a composite image based on the plurality of images, displaying the composite image on a screen, detecting a user's eyes in real time, selecting an image belonging to the composite image and corresponding to an area watched by the user, and sending the selected image.

The image transmission device may generate a single image including the plurality of images in addition to the plurality of images obtained by the plurality of cameras.

The image transmission device may divide the composite image into a plurality of areas, may determine that the detected eyes looks at which area of the plurality of areas, and may select an image corresponding to the area watched by the user based on the determination.

The plurality of areas may correspond to the plurality of images obtained by the plurality of cameras. The image transmission device may select an image corresponding to a previously determined area if it is detected that the user looks at an area other than the screen.

The selected image may have the same size and resolution as an image obtained by a single camera. The plurality of cameras may include a main camera and at least one sub-camera.

Meanwhile, in order to accomplish the object of the present invention, in yet another aspect, the present invention provides an image transmission system. The image transmission system may include a plurality of cameras; and an image transmission device receiving a plurality of images obtained by a plurality of cameras, generating a composite image based on the plurality of images, displaying the composite image on a screen, and changing an area to be transmitted in the composite image in response to a change in an area watched by a user by tracking the user's eyes in real time.

Meanwhile, in order to accomplish the object of the present invention, in yet another aspect, the present invention provides an image transmission device. The image transmission device may include a reception unit receiving a plurality of images obtained by a plurality of cameras; a composite image generation unit generating a composite image based on the plurality of images; a display unit displaying the composite image on a screen; an eye tracking unit tracking a user's eyes in real time; and an image selection unit changing an area to be transmitted in the composite image in response to a change in an area watched by a user based on a tracking of the eye tracking unit.

Meanwhile, in order to accomplish the object of the present invention, in yet another aspect, the present invention provides an image transmission method. The image transmission method is performed by an image transmission device and may include the steps of receiving a plurality of images obtained by a plurality of cameras; generating a composite image based on the plurality of images; displaying the composite image on a screen; tracking a user's eyes in real time; and changing an area to be transmitted in the composite image in response to a change in an area watched by the user based on the tracking step.

### Advantageous Effects

As described above, in accordance with the present invention, a composite image is generated by obtaining a plurality of images based on a plurality of cameras and displayed, and a transmission image can be automatically switched in real time in response to the eyes of a user who performs broadcasting. Accordingly, more dynamic broadcasting is made possible in personal broadcasting that is difficult to include an expensive camera equipment or transmission system.

### DESCRIPTION OF DRAWINGS

FIG. 1 is a block diagram showing the configuration of a system for realizing an image transmission method based on eye tracking according to a preferred embodiment of the present invention.

FIG. 2 is an exemplary diagram showing the locations where a plurality of cameras is disposed according to a preferred embodiment of the present invention.

FIG. 3 is a block diagram showing the configuration of an image transmission device shown in FIG. 1.

FIG. 4 is a flowchart for illustrating a flow of the operation of the image transmission device shown in FIG. 3 and shows a flow of an image transmission method according to a preferred embodiment of the present invention.

FIG. 5 is an exemplary diagram illustratively showing a plurality of images obtained by a plurality of cameras.

FIG. 6 is an exemplary diagram illustratively showing a composite image generated based on the plurality of images shown in FIG. 5.

FIG. 7 is an exemplary diagram illustratively showing a plurality of areas included in the composite image.

FIGS. 8 and 9 are exemplary diagrams for illustrating broadcasting content that moves in real time in response to a user's eyes.

### MODE FOR INVENTION

Hereinafter, preferred embodiments of the present invention are described in more detail with reference to the accompanying drawings. In describing the present invention, in order to facilitate general understanding, the same reference numerals are used to denote the same elements throughout the drawings, and a redundant description of the same elements is omitted.

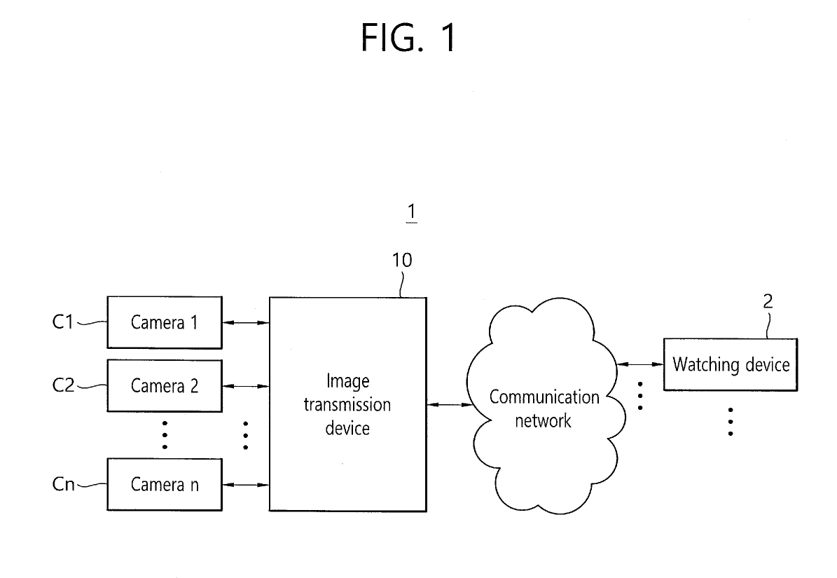

FIG. 1 is a block diagram showing the configuration of a system for realizing an image transmission method based on eye tracking according to a preferred embodiment of the present invention.

As shown in FIG. 1, FIG. 1 is a block diagram showing the configuration of a system for realizing an image transmission method based on eye tracking according to a preferred embodiment of the present invention.

As shown in FIG. 1, the image transmission device 10 of the system 1 may operate in conjunction with a plurality of cameras C1˜Cn in a wired or wireless way. The image transmission device 10 may operate in conjunction with a communication network, such as the Internet, and provide a broadcasting service to a watching device 2 based on images obtained by the plurality of cameras C1˜Cn. A broadcasting service server may be included between the image transmission device 10 and the watching device 20.

The image transmission device 10 may operate in conjunction with n (n is an integer greater than 2) cameras C1˜Cn. For example, in a preferred embodiment of the present invention, the image transmission device 10 may operate in conjunction with nine cameras. That is, in the description of the present embodiment, a case where n is assumed to be 9 is described. In this case, the nine cameras may include one main camera and eight sub-cameras. However, such an embodiment is not limited, and the number and roles of cameras may be changed and implemented in various ways. Each of the cameras may obtain an image and send the obtained image to the image transmission device 10 through a wired or wireless way.

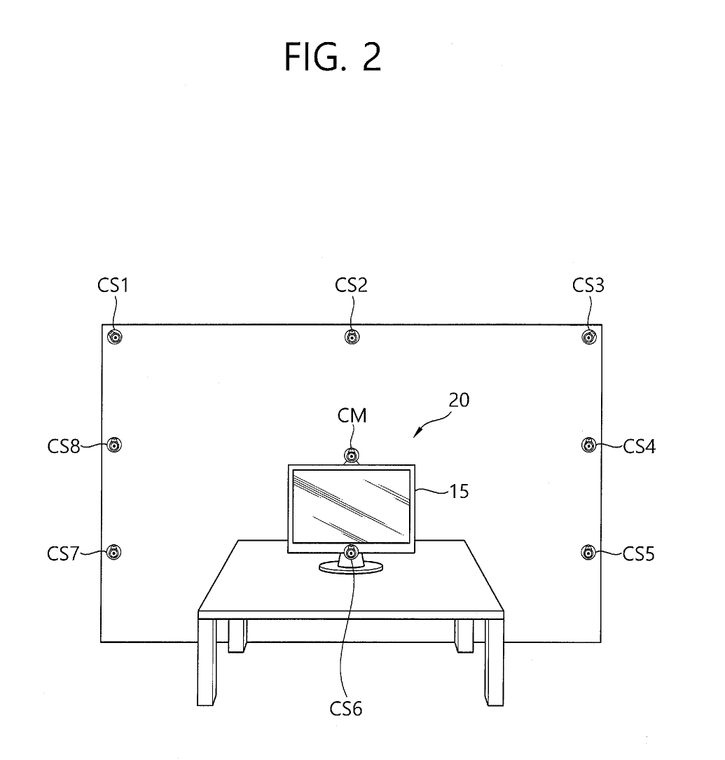

FIG. 2 is an exemplary diagram showing the locations where a plurality of cameras is disposed according to a preferred embodiment of the present invention.

As shown in FIG. 2, in the description of the present embodiment, nine cameras are assumed to be included and are described. For example, the image transmission device 10 may operate in conjunction with one main camera CM and eight sub-cameras CS1˜CS8.

The main camera CM may be provided on one side of a monitor 15, for example, in the middle of the top (that is, the upper middle) of the monitor. The sub-cameras CS1˜CS8 are provided at designated positions of the monitor or a studio. For example, the sub-camera 1 CS1 may be provided at the upper left end of the front of the studio. The sub-camera 2 CS2 may be provided in the upper middle of the front of the studio. The sub-camera 3 CS3 may be provided at the upper right end of the front of the studio. The sub-camera 4 CS4 may be provided in the right middle part of the front of the studio. The sub-camera 5 CS5 may be provided in the right lower part of the front of the studio. The sub-camera 6 CS6 may be provided in the lower middle of the front of the studio or the lower middle of the monitor. The sub-camera 7 CS7 may be provided in the left lower part of the front of the studio. The sub-camera 8 CS8 may be provided in the left middle part of the studio.

Since the eight sub-cameras CS1˜CS8 are disposed in several places of the studio as described above, the image transmission device 10 may obtain an image of a wider range compared to a case where only one main camera CM is included.

The locations of the plurality of cameras may be changed in various ways. For example, as in an around view applied to a vehicle, a plurality of cameras may be disposed around the table of a monitor to obtain a plurality of images for an around view image or a plurality of cameras for obtaining a panorama image of 360 degrees may be disposed on the surface of a wall of a studio.

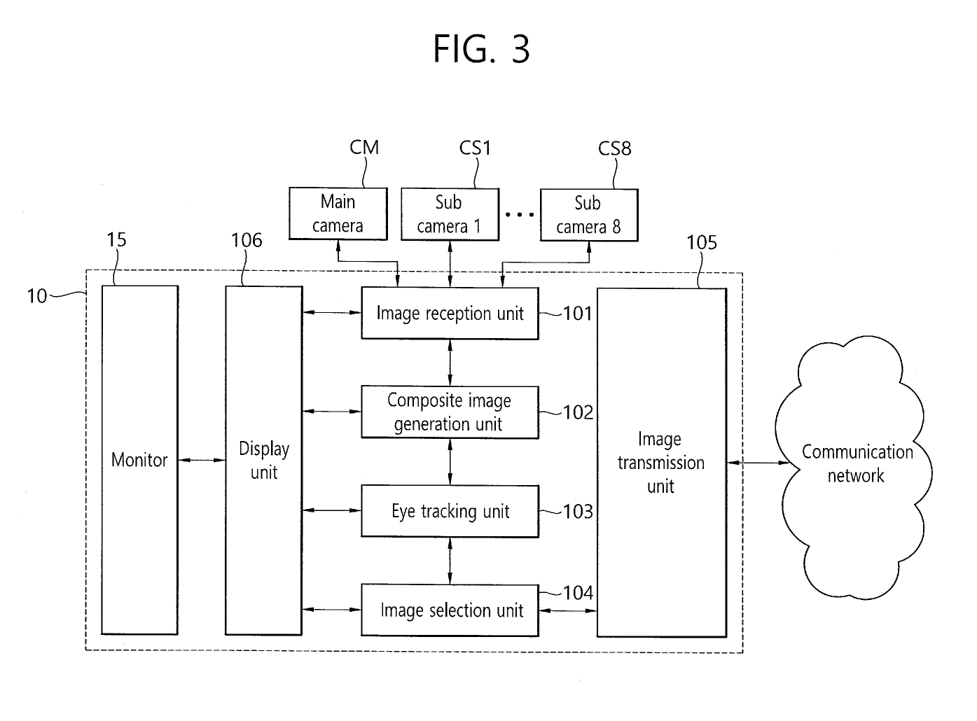

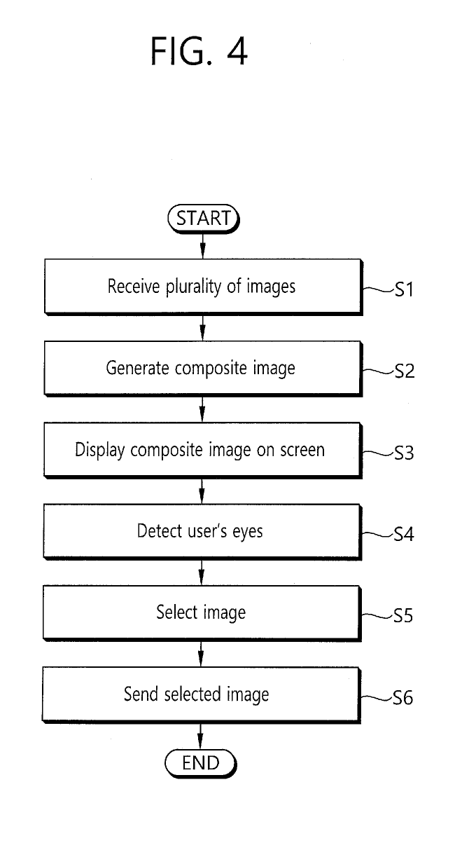

FIG. 3 is a block diagram showing the configuration of the image transmission device 10 shown in FIG. 1. FIG. 4 is a flowchart for illustrating a flow of the operation of the image transmission device 10 shown in FIG. 3 and shows a flow of an image transmission method according to a preferred embodiment of the present invention.

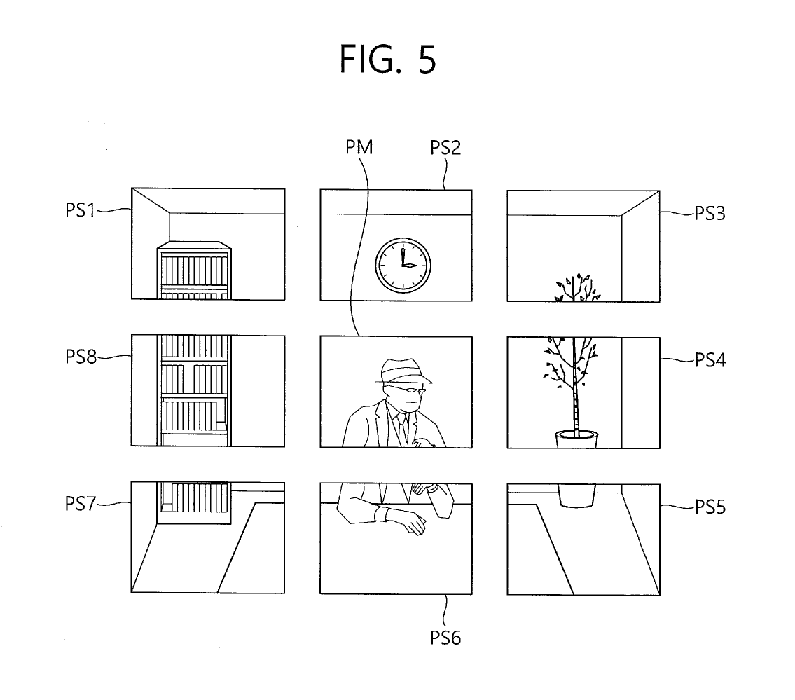

As shown in FIG. 5, the image transmission device 10 may include an image reception unit 101, a composite image generation unit 102, an eye tracking unit 103, an image selection unit 104, an image transmission unit 105, a display unit 106, a monitor 15, and so on.

The image transmission device 10 may operate in conjunction with the plurality of cameras CM and CS1˜CS8, for example, the main camera CM and the eight sub-cameras CS1˜CS8. On the other hand, the image transmission device 10 may provide a broadcasting service using images captured by the plurality of cameras CM and CS1˜CS8, for example, the main camera CM and the eight sub-cameras CS1˜CS8 over a communication network.

Referring to FIGS. 3 and 4, the image reception unit 101 of the image transmission device 10 may obtain a plurality of images using the plurality of cameras CM and CS1˜CS8 (step: S1). For example, the image reception unit 101 may obtain a main image, a sub-image 1, a sub-image 2, a sub-image 3, a sub-image 4, a sub-image 5, a sub-image 6, a sub-image 7 and a sub-image 8 from the main camera CM, the sub-camera 1 CS1, the sub-camera 2 CS2, the sub-camera 3 CS3, the sub-camera 4 CS4, the sub-camera 5 CS5, the sub-camera 6 CS6, the sub-camera 7 CS7 and the sub-camera 8 CS8, respectively.

The composite image generation unit 102 may generate a composite image based on the plurality of images obtained by the plurality of cameras CM and CS1˜CS8 (step: S2). In this case, the composite image is an image of the addition of the plurality of images, and may be a single image including at least part of each of the images.

FIG. 5 is an exemplary diagram illustratively showing a plurality of images obtained by the plurality of cameras CM and CS1˜CS8.

As shown in FIG. 5, the main camera CM may obtain a front image of a user who performs broadcasting as a main image PM. The remaining sub-cameras CS1˜CS8 may obtain images of parts that belongs to the studio and that cannot be obtained by the main camera CM.

Accordingly, the image transmission device 10 may obtain various images up to all of the corners of the studio by receiving the main image PM, the sub-image 1 PS1, the sub-image 2 PS2, the sub-image 3 PS3, the sub-image 4 PS4, the sub-image 5 PS5, the sub-image 6 PS6, the sub-image 7 PS7 and the sub-image 8 PS8 from the main camera CM, the sub-camera 1 CS1, the sub-camera 2 CS2, the sub-camera 3 CS3, the sub-camera 4 CS4, the sub-camera 5 CS5, the sub-camera 6 CS6, the sub-camera 7 CS7 and the sub-camera 8 CS8, respectively.

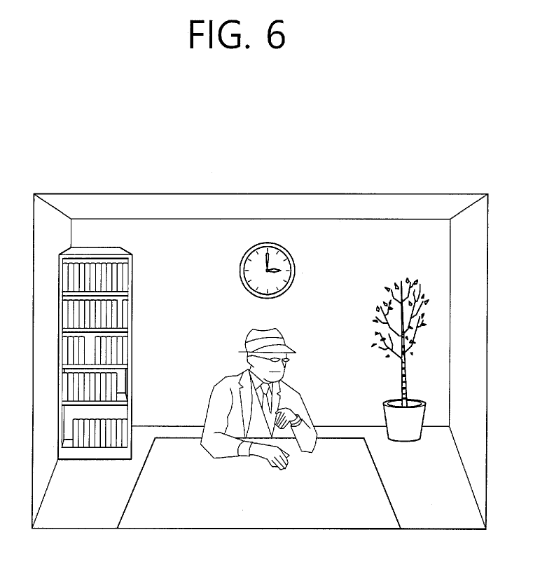

FIG. 6 is an exemplary diagram illustratively showing a composite image generated based on the plurality of images PM and PS1˜PS8 shown in FIG. 5.

As shown in FIG. 6, if the obtained 9 images PM and PS1˜PS8 shown in FIG. 5 are composed, an image of a very wide range capable of covering the entire studio, that is, a composite image, can be obtained.

Meanwhile, an image capable of being obtained through composition is various depending on the arrangement of a plurality of cameras. For example, if a plurality of cameras is disposed around the table of a monitor, a composite image, such as an image of an around view of a vehicle, may be generated. Alternatively, if cameras are disposed on the surface of a wall of a studio in an arrangement for obtaining a 360-degree panorama image, an image of a form, such as a 360-degree panorama image, may be obtained through composition.

The composite image generation unit 102 may overlap part of at least one image, obtained when composing a plurality of images, with another image or may cut part of the obtained at least one image. For example, there is a possibility that an upper part of the main image PM and a lower part of the sub-image 2 PS2 may be obtained as the same image. In this case, when composing the images, the composite image generation unit 102 may cut at least any one of the upper part of the main image PM and the lower part of the sub-image 2 PS2 or may overlap the upper part of the main image PM and the lower part of the sub-image 2 PS2.

When the composite image is generated, the display unit 106 may display the generated composite image in at least part of a screen of the monitor 15 (step: S3). For example, the display unit 106 may display a composite image, such as that shown in FIG. 6, on the entire screen. Meanwhile, according to an implementation environment, the display unit 106 may generate a sub-screen of a previously determined size in part of a screen and display a composite image using the generated sub-screen.

Next, the eye tracking unit 103 may detect a user's eyes in real time in the state in which the composite image has been displayed on the screen of the monitor 15 (step: S4). That is, an area being watched by the user continues to be detected. The eye tracking unit 103 may include an eye tracking sensor (not shown) provided on one side of the monitor 15, for example. The eye tracking sensor may be disposed in various ways depending on an implementation environment. For example, the eye tracking unit 103 may be equipped with a dedicated detection sensor and the main camera CM or at least any one of the sub-cameras CS1˜CS8 may also play the role of an eye tracking sensor.

Next, the image selection unit 104 may select an image corresponding to the area being watched by the user based on the detection of the eyes of the eye tracking unit 103 (step: S5).

The composite image may be divided into a plurality of areas. When the composite image is generated, the image selection unit 104 may divide the composite image into a plurality of logical areas. The division of the areas cannot be perceived by the user because the areas are not displayed on a screen when the composite image is displayed. For example, the plurality of areas may correspond to the plurality of images PM and PS1˜PS8 obtained by the plurality of cameras CM and CS1˜CS8. However, this is not limited and a plurality of areas may be randomly set depending on an implementation environment.

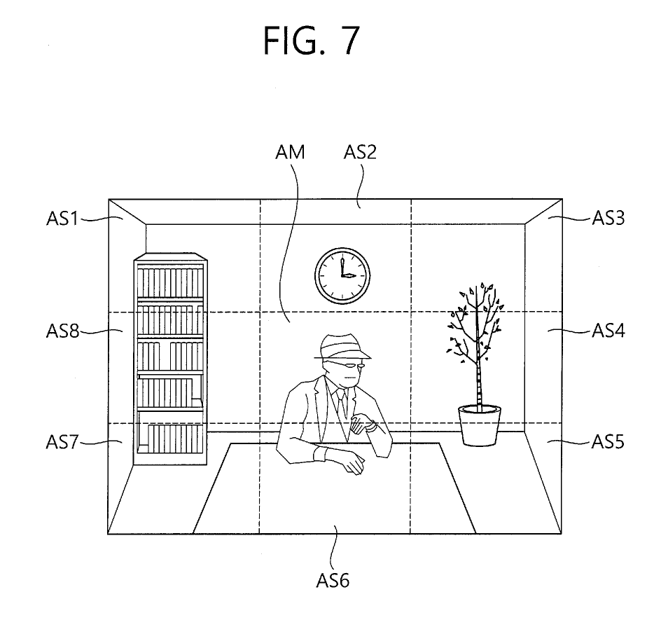

FIG. 7 is an exemplary diagram illustratively showing a plurality of areas included in the composite image.

As shown in FIG. 7, the composite image may be divided into nine areas AM and AS1˜AS8, for example, a main area AM, a sub-area 1 AS1, a sub-area 2 AS2, a sub-area 3 AS3, a sub-area 4 AS4, a sub-area 5 AS5, a sub-area 6 AS6, a sub-area 7 AS7 and a sub-area 8 AS8.

In this case, the main area AM may correspond to the main image PM obtained by the main camera CM, the sub-areal AS1 may correspond to the sub-image 1 PS1, the sub-area 2 AS2 may correspond to the sub-image 2 PS2, the sub-area 3 AS3 may correspond to the sub-image 3 PS3, the sub-area 4 AS4 may correspond to the sub-image 4 PS4, the sub-area 5 AS5 may correspond to the sub-area 5 PS5, the sub-area 6 AS6 may correspond to the sub-image 6 PS6, the sub-area 7 AS7 may correspond to the sub-image 7 PS7, and the sub-area 8 AS8 may correspond to the sub-image 8 PS8.

In this case, the image selection unit 104 may determine that the user looks at which area of the plurality of areas AM and AS1˜AS8 divided in the composite image, and may select an image that belongs to the plurality of images PM and PS1˜PS8 and that corresponds to the area watched by the user based on the determination.

The selected image may have the same size and resolution as an image captured by a single camera. For example, when the user looks at the main area AM in the composite image, the main image PM may be selected. When the user looks at the sub-area 1 AS1 in the composite image, the sub-image PS1 may be selected.

As described above, however, according to an implementation environment, the division of a composite image may not correspond to an image of a camera. For example, a divided area of a composite area may be smaller than or greater than an image of a camera. In this case, the image selection unit may select an image by dividing an image corresponding to an area watched by a user from the composite image.

Meanwhile, if the eye tracking unit 103 detects that the user looks at an area other than the composite image, for example, the outside, back, etc. of the monitor 15 or the detection of the eyes is impossible, the image selection unit 104 may select an image that belongs to the plurality of images and that has been previously determined.

For example, if the main image PM has been defined a default image and when the user looks at the place other than the monitor 15 or looks aside or back, the image selection unit 104 may select the main image PM. The image selection unit 104 may display a user interface in which the default image can be previously set and select the default image in response to a signal selected through the user interface.

The transmission unit 105 may broadcast an image selected by the eye tracking unit 103 over a communication network. Accordingly, an image can be changed in real time in a wide area because the watching device that receives an image served by the image transmission device 10 and plays back the received image plays back an image that belongs to a composite image and that corresponds to an area now watched by a user. Accordingly, a viewer can watch an image that dynamically moves in a wide range instead of a narrow and monotonous image obtained by a single camera.

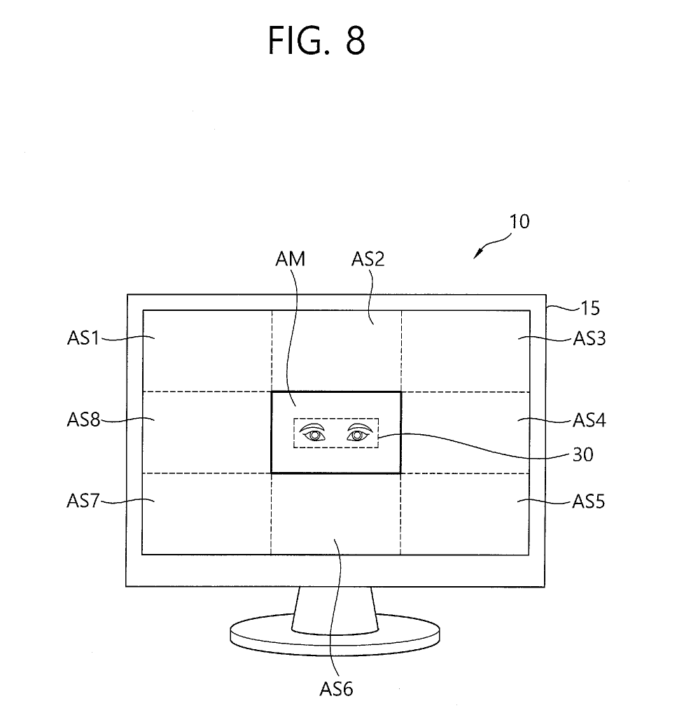

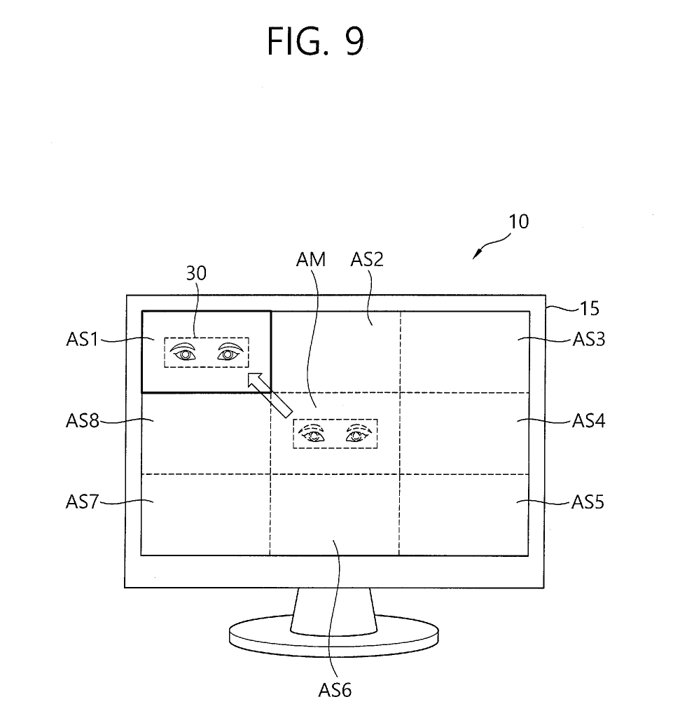

FIGS. 8 and 9 are exemplary diagrams for illustrating broadcasting content that moves in real time in response to a user's eyes.

As shown in FIG. 8, a composite image is displayed on a screen of the monitor 15 of a user who performs broadcasting, and the user's eyes look at the main area AM in the composite image. At this time, the image transmission device 10 may send the main image PM corresponding to the main area AM, that is, an image obtained by the main camera CM. Accordingly, a viewer now watches the main image PM.

Next, as shown in FIG. 9, if the gazing of the user's eyes has moved from the main area AM to the sub-area 1 AS1 in the composite image, the image transmission device 10 may stop the transmission of the main image PM, may select the sub-image 1 PM1 corresponding to the sub-area 1 AS1, and may send the selected sub-image 1 PM1. Accordingly, the viewer watches an image that has moved from the main image PM to the sub-image 1 PS1 in real time.

As described above, in accordance with the present invention, a composite image is generated by obtaining a plurality of images based on a plurality of cameras and displayed, and a transmission image can be automatically switched in real time in response to the eyes of a user who performs broadcasting. Accordingly, more dynamic broadcasting is made possible in personal broadcasting that is difficult to include an expensive camera equipment or transmission system.

Although the preferred embodiments of the present invention have been described above, those skilled in the art will appreciate that the present invention may be modified and changed in various ways without departing from the technological contents and scope of the present invention written in the appended claims. Accordingly, a change of the future embodiments of the present invention will not depart from the technology of the present invention.

1. An image transmission method based on eye tracking, the method being performed by an image transmission device and comprising steps of:
receiving a plurality of images obtained by a plurality of cameras;
generating a composite image based on the plurality of images;
displaying the composite image on a screen;
detecting a user's eyes in real time;
selecting an image belonging to the composite image and corresponding to an area watched by the user; and
sending the selected image.

2. The image transmission method of claim 1, wherein the step of generating the composite image comprises a step of generating a single image comprising the plurality of images in addition to the plurality of images obtained by the plurality of cameras.

3. The image transmission method of claim 1, wherein the step of selecting the image comprises steps of:
dividing the composite image into a plurality of areas;
determining that the detected eyes looks at which area of the plurality of areas; and
selecting an image corresponding to the area watched by the user based on the determining step.

4. The image transmission method of claim 3, wherein the plurality of areas corresponds to the plurality of images obtained by the plurality of cameras.

5. The image transmission method of claim 1, wherein the step of selecting the image comprises a step of selecting an image corresponding to a previously determined area if it is detected that the user looks at an area other than the screen.

6. The image transmission method of claim 1, wherein the selected image has a size and resolution identical with a size and resolution of an image obtained by a single camera.

7. The image transmission method of claim 1, wherein the plurality of cameras comprises a main camera and at least one sub-camera.

8. An image transmission device based on eye tracking, comprising:
an image reception unit receiving a plurality of images obtained by a plurality of cameras;
a composite image generation unit generating a composite image based on the plurality of images;
a display unit displaying the composite image on a screen;
an eye tracking unit detecting a user's eyes in real time;
an image selection unit selecting an image belonging to the composite image and corresponding to an area watched by the user; and
an image transmission unit sending the selected image.

9. The image transmission device of claim 8, wherein the composite image generation unit generates a single image comprising the plurality of images in addition to the plurality of images obtained by the plurality of cameras.

10. The image transmission device of claim 8, wherein the image selection unit divides the composite image into a plurality of areas, determines that the detected eyes looks at which area of the plurality of areas, and selects an image corresponding to the area watched by the user based on the determination.

11. The image transmission device of claim 10, wherein the plurality of areas corresponds to the plurality of images obtained by the plurality of cameras.

12. The image transmission device of claim 8, wherein the image selection unit selects an image corresponding to a previously determined area if it is detected that the user looks at an area other than the screen.

13. The image transmission device of claim 8, wherein the selected image has a size and resolution identical with a size and resolution of an image obtained by a single camera.

14. The image transmission device of claim 8, wherein the plurality of cameras comprises a main camera and at least one sub-camera.

15. An image transmission system based on eye tracking, comprising:
a plurality of cameras; and
an image transmission device receiving a plurality of images obtained by a plurality of cameras, generating a composite image based on the plurality of images, displaying the composite image on a screen, detecting a user's eyes in real time, selecting an image belonging to the composite image and corresponding to an area watched by the user, and sending the selected image.

16. The image transmission system of claim 15, wherein the image transmission device generates a single image comprising the plurality of images in addition to the plurality of images obtained by the plurality of cameras.

17. The image transmission system of claim 15, wherein the image transmission device divides the composite image into a plurality of areas, determines that the detected eyes looks at which area of the plurality of areas, and selects an image corresponding to the area watched by the user based on the determination.

18. An image transmission system, comprising:
a plurality of cameras; and
an image transmission device receiving a plurality of images obtained by a plurality of cameras, generating a composite image based on the plurality of images, displaying the composite image on a screen, and changing an area to be transmitted in the composite image in response to a change in an area watched by a user by tracking the user's eyes in real time.

19. An image transmission device, comprising:
a reception unit receiving a plurality of images obtained by a plurality of cameras;
a composite image generation unit generating a composite image based on the plurality of images;
a display unit displaying the composite image on a screen;
an eye tracking unit tracking a user's eyes in real time; and
an image selection unit changing an area to be transmitted in the composite image in response to a change in an area watched by a user based on a tracking of the eye tracking unit.

20. An image transmission method being performed by an image transmission device and comprising steps of:
receiving a plurality of images obtained by a plurality of cameras;
generating a composite image based on the plurality of images;
displaying the composite image on a screen;
tracking a user's eyes in real time; and
changing an area to be transmitted in the composite image in response to a change in an area watched by the user based on the tracking step.
